(19) United States
(12) Patent Application Publication
(10) Pub. No.: US 2005/0136997 A1
(43) Pub. Date: Jun. 23, 2005

(54) Wireless communication device

(76) Inventors: Barrett Kreiner, Norcross, GA (US); Ronald J. Perrella, Norcross, GA (US)

Correspondence Address: LEE & HAYES, PLLC, 421 W. RIVERSIDE AVE., SUITE 500, SPOKANE, WA, 99201, US

(21) Appl. No.: 10/745,453

(22) Filed: Dec. 23, 2003

(51) Int. Cl. H04M 1/00

(52) U.S. Cl. 455/575.1

(57) ABSTRACT

A wireless communication device is disclosed. The wireless communication device includes a detector, a digital signal processor, and a controller coupled to the detector and the digital signal processor. The digital signal processor is for generating a ringing signal. The controller is for instructing the digital signal processor to terminate the ringing signal when the detector detects a blow to the wireless communication device.

### BACKGROUND

The present application is related, generally and in various embodiments, to a wireless communication device. There are many times throughout a day when a person cannot be reached via a landline telephone. To make themselves more accessible to others, many people now carry a wireless communication device such as a wireless telephone or a wireless pager with them. The wireless communication device is often clipped to a person's belt, carried in a pocket, or carried in a purse, a satchel, a backpack or a briefcase.

When a person who carries a wireless communication device cannot be reached via a landline telephone, they can often be reached by simply calling a number associated with the wireless communication device. When the call is connected to the wireless communication device, the wireless communication device typically generates a sound such as a ringing sound to alert the person that they are being called or paged.

To silence the sound generated by the wireless communication device, the person can answer the call, acknowledge the page, or turn off the wireless communication device. Unfortunately, such actions can take a relatively long time to carry out and there are times when it is desirous to quickly silence the sound generated by the wireless communication device.

### SUMMARY

In one general respect, this application discloses embodiments of a wireless communication device. According to various embodiments, the wireless communication device includes a detector, a digital signal processor, and a controller coupled to the detector and the digital signal processor. The digital signal processor is for generating a ringing signal. The controller is for instructing the digital signal processor to terminate the ringing signal when the detector detects a blow to the wireless communication device.

In another general respect, this application discloses a method for terminating a ringing of a wireless communication device. According to various embodiments, the method includes detecting a blow to the wireless communication device, notifying a controller of the blow, and instructing a digital signal processor to terminate a ringing signal.

Other embodiments of the disclosed invention will be or become apparent to one skilled in the art upon review of the following drawings and detailed description. It is intended that all such additional embodiments be included within this description, be within the scope of the disclosed invention, and be protected by the accompanying claims.

### BRIEF DESCRIPTION OF THE DRAWINGS

FIG. 1 is a simplified block diagram of a wireless communication device according to various embodiments; and

FIG. 2 illustrates various embodiments of a process flow for terminating a ringing of the wireless communication device of FIG. 1.

### DETAILED DESCRIPTION

It is to be understood that the figures and descriptions of the present invention have been simplified to illustrate elements that are relevant for a clear understanding of the present invention, while eliminating, for purposes of clarity, other elements. For example, a modulator/demodulator, a coder/decoder, a display and a memory unit are not described or illustrated herein. Those of ordinary skill in the art will recognize, however, that these and other elements may be desirable. However, because such elements are well known in the art, and because they do not facilitate a better understanding of the present invention, a discussion of such elements is not provided herein.

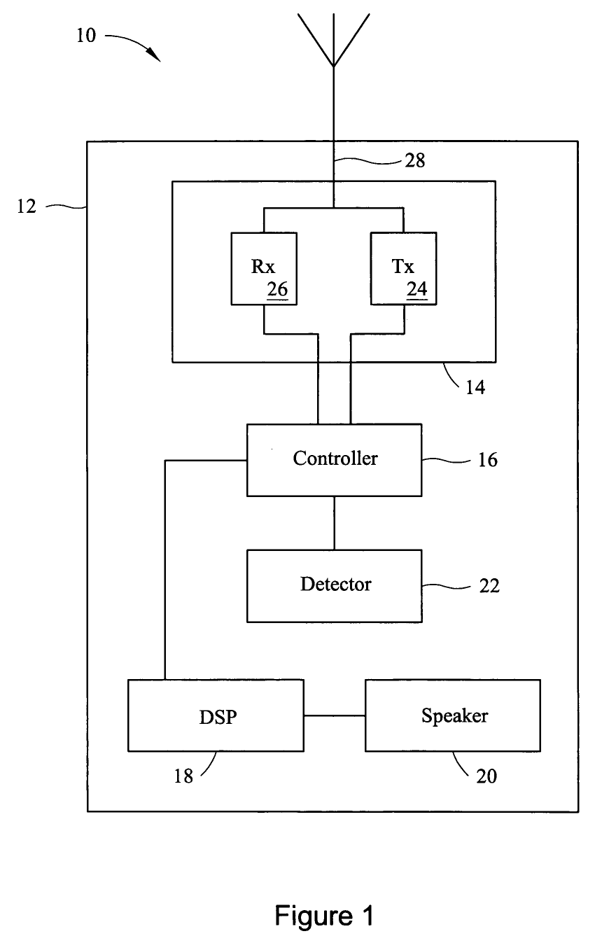

FIG. 1 illustrates various embodiments of a wireless communication device 10. According to various embodiments, the wireless communication device 10 is a wireless telephone. According to other embodiments, the wireless communication device 10 is a wireless pager.

The wireless communication device 10 includes a housing 12. The housing 12 is fabricated from a plastic and serves to cover internal components of the wireless communication device 10 and protect them from exposure to the elements. The wireless communication device 10 also includes a transceiver 14, a controller 16, a digital signal processor 18, a speaker 20 and a detector 22. The transceiver 14, the controller 16, the digital signal processor 18, the speaker 20 and the detector 22 are connected to a printed circuit board (not shown) positioned within the housing 12.

The transceiver 14 is coupled to the controller 16 and includes a RF transmitter amplifier 24 coupled to the controller 16, an RF receiver amplifier 26 coupled to the controller 16, and an antenna 28 coupled to the RF transmitter amplifier 24 and the RF receiver amplifier 26.

The digital signal processor 18 is coupled to the controller 16 and is for generating a ringing signal when an incoming call is connected to the wireless communication device 10. As used herein, an incoming call refers to any incoming message such as a telephone call or a page. The speaker 20 is coupled to the digital signal processor 18 and is for converting the ringing signal generated by the digital signal processor 18 into a ringing sound that serves to alert a user of the wireless communication device 10 of an incoming call. The detector 22 is coupled to the controller 14 and is for detecting a blow delivered to the wireless communication device 10.

The controller 16 is a microcontroller that serves to control and coordinate the functionality of the wireless communication device 10. The controller 16 is for instructing the digital signal processor 18 to terminate the ringing signal when the detector 22 detects a blow delivered to the wireless communication device 10.

According to various embodiments, the detector 22 includes a normally-open switch that closes when a blow is delivered to the wireless communication device 10. The closing of the normally-open switch electrically connects the detector 22 to the controller 16 and serves to notify the controller 16 that the detector 22 has detected a blow delivered to the wireless communication device 10.

According to various embodiments, the detector 22 includes a normally-closed switch that opens when a blow is delivered to the wireless communication device 10. The opening of the normally-closed switch electrically disconnects the detector 22 from the controller 16 and serves to notify the controller 16 that the detector 22 has detected a blow delivered to the wireless communication device 10.

According to various embodiments, the detector 22 includes a momentary switch that momentarily makes or breaks an electrical connection between the detector 22 and the controller 16 when a blow is delivered to the wireless communication device 10. The momentary making or breaking of the electrical connection between the detector 22 and the controller 16 serves to notify the controller 16 that the detector 22 has detected a blow delivered to the wireless communication device 10.

According to various embodiments, the detector 22 includes an inertia switch that makes or breaks an electrical connection between the detector 22 and the controller 16 when a blow is delivered to the wireless communication device 10.

According to various embodiments, the detector 22 includes an omnidirectional switch that is equally sensitive in all directions and can detect a blow delivered to the wireless communication device 10 from any direction.

According to various embodiments, the sensitivity of the detector 22 is fixed. For such embodiments, the detector 22 recognizes a blow delivered to the wireless communication device 10 when the blow imparts a force greater than a predetermined threshold, but does not recognize a blow delivered to the wireless communication device 10 when the blow imparts a force less than the predetermined threshold. According to other embodiments, the sensitivity of the detector 22 is adjustable in that the predetermined threshold can be set higher or lower at any time.

According to various embodiments, the detector 22 is a solid-state accelerometer that makes or breaks an electrical connection between the detector 22 and the controller 16 when a blow is delivered to the wireless communication device 10. According to various embodiments, the detector 22 is a single-axis accelerometer. According to other embodiments, the detector 22 is a dual-axis accelerometer. According to yet other embodiments, the detector 22 is a tri-axis accelerometer.

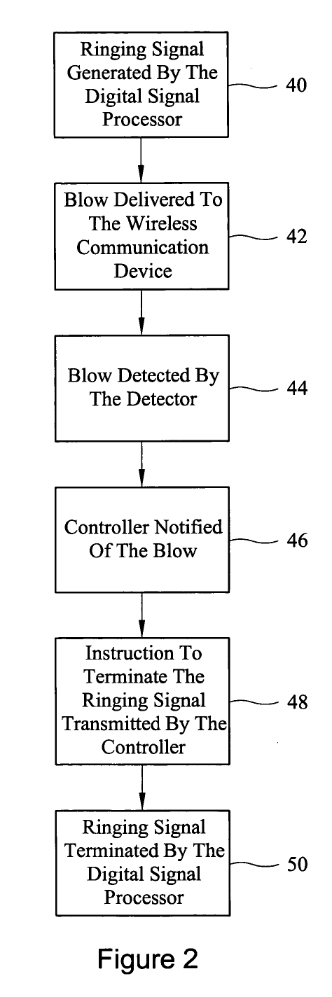

FIG. 2 illustrates various embodiments of a process flow for terminating a ringing of the wireless communication device 10. The process begins at block 40, where the digital signal processor 16 generates a ringing signal to alert a user of the wireless communication device 10 when an incoming call is connected to the wireless communication device 10.

From block 40, the process advances to block 42, where a blow is delivered to the wireless communication device 10. According to various embodiments, a user of the wireless communication device 10 delivers the blow to the wireless communication device 10 by striking, slapping, smacking or shaking the wireless communication device 10.

From block 42, the process advances to block 44, where the detector 22 detects the blow delivered to the wireless communication device 10 and makes or breaks an electrical connection between the detector 22 and the digital signal processor 18. From block 44, the process advances to block 46, where the controller 16 is notified that the detector 22 has detected the blow delivered to the wireless communication device 10.

From block 46, the process advances to block 48, where the controller 16 transmits an instruction to the digital signal processor 18 to terminate the ringing signal. From block 48, the process advances to block 50, where the digital signal processor 18 receives the instruction from the controller 16 and terminates the ringing signal in response thereto. When the ringing signal is terminated, the ringing sound produced by the speaker 20 is silenced.

While several embodiments of the disclosed invention have been described, it should be apparent, however, that various modifications, alterations and adaptations to those embodiments may occur to persons skilled in the art with the attainment of some or all of the advantages of the disclosed invention. For example, according to various embodiments, the controller 16, the digital signal processor 18, the speaker 20 and the detector 22 comprise a portion of a device such as a walkie-talkie, a portable radio, an alarm clock, etc. For such embodiments, the digital signal processor 18 is for generating an alarm signal and the controller 16 is for instructing the digital signal processor 18 to terminate the alarm signal when the detector 22 detects a blow to the device. Thus, for any device that includes the controller 16, the digital signal processor 18, the speaker 20 and the detector 22, the ringing or alarm sound emanating from the speaker 20 can be silenced by simply delivering a blow to the device. It is therefore intended to cover all such modifications, alterations and adaptations without departing from the scope and spirit of the disclosed invention as defined by the appended claims.

1. A wireless communication device, comprising:
a detector;
a digital signal processor for generating a ringing signal; and
a controller coupled to the detector and the digital signal processor, wherein the controller is for instructing the digital signal processor to terminate the ringing signal when the detector detects a blow to the wireless communication device.

2. The wireless communication device of claim 1, wherein the wireless communication device is a wireless telephone.

3. The wireless communication device of claim 1, wherein the wireless communication device is a wireless pager.

4. The wireless communication device of claim 1, wherein the detector includes a normally-open switch.

5. The wireless communication device of claim 1, wherein the detector includes a normally-closed switch.

6. The wireless communication device of claim 1, wherein the detector includes a momentary switch.

7. The wireless communication device of claim 1, wherein the detector includes an inertia switch.

8. The wireless communication device of claim 1, wherein the detector includes an omnidirectional switch.

9. The wireless communication device of claim 1, wherein a sensitivity of the detector is fixed.

10. The wireless communication device of claim 1, wherein a sensitivity of the detector is adjustable.

11. The wireless communication device of claim 1, wherein the detector is an accelerometer.

12. The wireless communication device of claim 11, wherein the accelerometer is a solid-state accelerometer.

13. The wireless communication device of claim 11, wherein the accelerometer is a single-axis accelerometer.

14. The wireless communication device of claim 11, wherein the accelerometer is a dual-axis accelerometer.

15. The wireless communication device of claim 11, wherein the accelerometer is a tri-axis accelerometer.

16. The wireless communication device of claim 1, further comprising a transceiver coupled to the controller.

17. The wireless communication device of claim 16, wherein the transceiver includes:
an RF transmitter amplifier coupled to the controller;
an RF receiver amplifier coupled to the controller; and
an antenna coupled to the RF transmitter amplifier and the RF receiver amplifier.

18. The wireless communication device of claim 1, further comprising a speaker coupled to the digital signal processor.

19. A wireless communication device, comprising:
a digital signal processor for generating a ringing signal;
means for detecting a blow to the wireless communication device; and
a controller coupled to the means for detecting and the digital signal processor, wherein the controller is for instructing the digital signal processor to terminate the ringing signal when the means for detecting the blow detects the blow.

20. A method for terminating a ringing of a wireless communication device, the method comprising:
detecting a blow to the wireless communication device;
notifying a controller of the blow; and
instructing a digital signal processor to terminate a ringing signal.
